(19) United States
(12) Patent Application Publication
(10) Pub. No.: US 2021/0312443 A1
(43) Pub. Date: Oct. 7, 2021

(54) ORCHESTRATION ENGINE FOR TRANSACTIONS

(71) Applicant: eBay Inc., San Jose, CA (US)

(72) Inventors: Samwedana SAUN, Cupertino, CA (US); Saurabh Sunil GHADI, San Jose, CA (US)

(21) Appl. No.: 16/840,062

(22) Filed: Apr. 3, 2020

(51) Int. Cl. G06Q 20/40; G06Q 20/22; G06F 9/54

(52) U.S. Cl. CPC G06Q 20/405; G06F 9/542; G06Q 20/227

(57) ABSTRACT

The disclosed technologies include receiving data indicative of a first transaction to be processed according to a first transaction method. Data indicative of a second transaction to be processed according to a second transaction method is received. The first and second transactions and the first and second transaction methods are analyzed based on requirements for the first and second transaction methods. Based on the analysis, it is determined if the first and second transactions can be processed in a single action. When the analysis indicates that the first and second transactions can be processed in a single action, the first and second transactions are processed as a single action. When the analysis indicates that the first and second transactions cannot be processed in a single action, an alternative process is executed.

### BACKGROUND

Many e-commerce sites offer products from multiple sources. Some sources restrict buyers to specified payment methods. For example, a first source may only take Visa, and a second source may only take PayPal. This scenario may require a number of extra steps for the end user to complete a transaction. The buyer may be required to remove some items from a cart in order to purchase the items eligible for a Visa payment. The buyer may later restart a new cart session to purchase the items that are eligible for a PayPal payment. Additionally, when multiple payment amounts need to be authorized, a fee may be charged for each authorization request, which adds complexity and cost for the e-commerce site.

It is with respect to these and other technical considerations that the disclosure made herein is presented.

### SUMMARY

Existing transaction systems present cumbersome and inefficient processes, particularly when multiple providers are involved. The situation can become more complex when the buyer has a credit amount or a coupon that they wish to apply, or when the e-commerce site imposes their own rules for transactions. The effort and delay required to navigate through multiple user actions as described above may have a number of detrimental effects. Such issues not only necessitate manually complex tasks that are inefficient with respect to computing resources, but can also create a barrier to sales as some buyers may not proceed with some or all of their potential purchases. For example, requiring the processing of multiple cart transactions, or retrying transactions due to transaction failures, may cause users to lose interest in purchasing the desired items. From a resource standpoint, processing numerous combinations of transactions may unnecessarily consume computing, storage, and network resources, as well as increase transaction costs for the e-commerce site. Additionally, some payment processors charge a fee for each authorization request. When multiple payment amounts need to be authorized, the sending of each authorization request not only adds cost for the e-commerce site, but further adds to the unnecessary use of computing, storage, and network resources.

The disclosed technologies address the technical problems presented above, and potentially others, by enabling a cart with multiple items to be processed in a single cart action even when different payment methods are required. In an embodiment, during checkout, the cart items, seller requirements, and payment requirements may be analyzed, and verification may be performed as to whether the cart can be processed in its entirety. Based on the analysis, the steps necessary to fulfill the entire cart action can be automatically performed. In an embodiment, the items in an e-commerce cart and their payment types may be analyzed according to their respective policies and payment processing requirements. Additionally, the number of authorization requests may be reduced by combining requests that are sent to a given payment processor.

Due to their potential complexity, the various transactions and their associated policies and payment processing requirements may be represented as a linked graph. The linked graph represents groupings based on payment types that are to be processed together. The linked graph is analyzed to verify that the entire set of transactions can be accomplished. Verification actions and other steps are executed to ensure that the entire set of transactions can be completed (e.g., verifying credit limits). Thus, unlike existing systems, shopping cart items requiring multiple payment types can be completed with a single user session. If the entire cart cannot be completed in a single user session, the buyer may be notified and provided options for reconfiguring the cart. In some embodiments, the cart may be partially processed. In some embodiments, multiple authorization requests may be combined into a fewer number of requests by combining the requests whenever possible.

The disclosed technologies thus allow for reduction of the amount of unnecessary user actions, thus reducing the waste of computing resources (e.g., amount of memory or number of processor cycles required to maintain all multiple payment processes) and network bandwidth (because numerous user requests may require network use). Other technical benefits not specifically mentioned herein can also be realized through implementations of the disclosed technologies.

The determination of payment requirements for a given set of transactions can be dependent upon a number of variables. For example, payment restrictions for a given payment type are typically based on a number of factors. These factors may include the geographic location of the buyer, the geographic location of the seller, the type and price of the item, and other factors. However, these factors typically change over the course of time. Correct determination of such values depends on updating the system as applicable rules change and are updated. However, the manual updating of systems and software to update the rules can be costly and time-consuming. This can be a particular challenge in the e-commerce context as such rules can change at variable and unpredictable times. If the system is not able to respond rapidly to such varied and unpredictable changes, the system may return inaccurate results.

When the payment rules are written into the software for an electronic transaction system, the encoding of the rules into software can be complex due to the large number of dependencies and conditions for correctly processing payments in a given situation. Furthermore, payment rules can be updated unexpectedly, which necessitates software updates. The effort and delay required to update systems and software due to changes in rules as described above may have a number of detrimental effects. For example, the effort and cost to update software may be a continuous drain on resources. From a resource standpoint, processing updates and troubleshooting incompatibilities may unnecessarily consume computing, storage, and network resources.

The present disclosure further provides a way to encode such rules using a format that enables the rules to be encoded and updated independently from the software. The various policies and requirements are represented using data that can be updated independently from the software and can be loaded during runtime. Updates to the policies and requirements (which can occur frequently) can thus be made without having to update the system software. The disclosed techniques can be used for any type of rules that have a number of dependencies that are subject to change.

The disclosed technologies address the technical problems presented above, and potentially others, by enabling an e-commerce system to quickly adapt to new payment processing rules. The disclosed technologies also allow for reduction of the amount of code variations, thus reducing the waste of computing resources (e.g., amount of memory or number of processor cycles required to maintain all combinations of configurations). Other technical benefits not specifically mentioned herein can also be realized through implementations of the disclosed technologies.

It should be appreciated that the subject matter described above and in further detail below can be implemented as a computer-controlled apparatus, a computer-implemented method, a computing device, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is a system diagram illustrating one embodiment disclosed herein;

FIG. 2A is a diagram illustrating an example set of transactions as disclosed herein;

FIG. 2B is a diagram illustrating an example set of transactions as disclosed herein;

FIG. 2C is a diagram illustrating an example set of transactions as disclosed herein;

FIG. 2D is a diagram illustrating an example set of transactions as disclosed herein;

FIG. 2E is a diagram illustrating an example set of transactions as disclosed herein;

FIG. 2F is a diagram illustrating an example set of transactions as disclosed herein;

FIG. 2G is a diagram illustrating an example set of transactions as disclosed herein;

FIG. 2H is a diagram illustrating an example set of transactions as disclosed herein;

FIG. 3 is a diagram showing aspects of an example system according to one embodiment disclosed herein;

FIG. 4 is a diagram showing an example user system according to one embodiment disclosed herein;

FIG. 5 is a flow diagram showing aspects of an illustrative routine, according to one embodiment disclosed herein;

FIG. 6 is a flow diagram showing aspects of an illustrative routine, according to one embodiment disclosed herein;

FIG. 7 is a computer architecture diagram illustrating aspects of an example computer architecture for a computer capable of executing the software components described herein.

FIG. 8 is a data architecture diagram showing an illustrative example of a computing environment.

### DETAILED DESCRIPTION

In various embodiments, the following Detailed Description presents technologies for enabling a cart with multiple items to be processed in a single cart action even when different payment methods are required. Additionally, the number of authorization requests sent to payment processors may be reduced. For example, items in a user cart can be from different sellers each having different payment methods and individual requirements. For instance, Seller A may allow Visa payments, and Seller B may restrict users to a PayPal payments. Furthermore, Visa payments for some banks may allow for multiple purchase transactions, while PayPal only allows a single purchase transaction. In an embodiment, during checkout, the cart items, seller requirements, and payment requirements may be analyzed, and verification may be performed as to whether the cart can be processed in its entirety. Based on the analysis, the steps necessary to fulfill the entire cart action can be automatically performed. Thus, unlike existing systems, shopping cart items requiring both Visa and PayPal payments can be completed with a single user session. If the entire cart cannot be completed in a single user session, the buyer is notified and may be asked to reconfigure the cart. Alternatively, a subset of the payments may be processed. Additionally, when a payment method allows for multiple transactions to be processed in a single request, those transactions may be combined into a single request.

In an embodiment, the items in an e-commerce cart and their payment types may be analyzed according to their respective policies and payment processing requirements. Due to their potential complexity, the policies and requirements may be represented as a linked graph. The linked graph represents groupings based on payment types that are to be processed together. The linked graph may be analyzed to verify that the entire set of transactions can be accomplished. Verification actions and other steps may be taken to ensure that the entire set of transactions can be completed (e.g., verifying credit limits).

Additionally, the various policies and requirements may be represented using data that can be updated independently from the software and can be loaded during runtime. Updates to the policies and requirements (which can occur frequently) can thus be made without having to update the system software.

It is to be appreciated that while the technologies disclosed herein are primarily described in the context of online e-commerce systems, the technologies described herein can be utilized to orchestration of payments in other contexts, which will be apparent to those of skill in the art. The techniques disclosed herein can improve user interaction with a computing device, which can increase productivity and help reduce the number of inadvertent, obsolete, or otherwise incorrect inputs. Also, by providing more accurate and efficient encoding of rules, a system can operate more efficiently with respect to the use of memory, processing resources, network resources, etc.

Referring to the appended drawings, in which like numerals represent like elements throughout the several FIGURES, aspects of various technologies for orchestration of payments will be described. In the following detailed description, references are made to the accompanying drawings that form a part hereof, and which are shown by way of illustration specific configurations or examples.

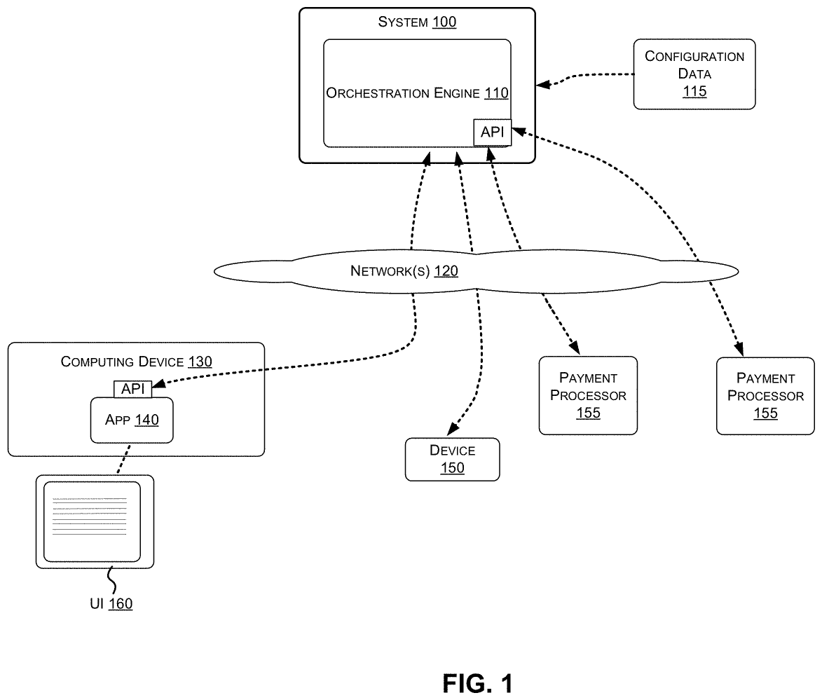

In the example system illustrated in FIG. 1, a system 100 is illustrated that implements orchestration engine 110. The orchestration engine 110 may be configured to analyze and orchestrate payments based on configuration data 115, communicate requests for payments to payment processors 155, and provide the results to various devices 150 over a network 120, as well as computing device 130. A user interface 160 may be rendered on computing device 130. The user interface 160 may be provided in conjunction with an application 140 that communicates to the system 100 using an API via network 120. In some embodiments, system 100 may be configured to provide e-commerce services to users. In one example, orchestration engine 110 may be configured to orchestrate payments based on configuration data 115, such as processing Visa and PayPal payments, and provide the results to computing device 130.

Online payments are typically processed by first authorizing a payment amount via an API call to a payment processor. A payment processor may be an entity that is authorized by a merchant to handle transactions from various sources such as credit cards and debit cards for merchant banks. The payment authorization may include, for example, determining if a user has a sufficient balance in the corresponding account to cover the purchase amount. Once authorized, a second API call may be processed to capture the payment account, which involves the actual transfer of funds from the payment account to cover the purchase amount.

Online e-commerce sites may offer items from different sellers. The sellers, in turn, may have different payment requirements. Each seller's requirements may have different ways to obtain authorization. Many users look for and attempt to purchase multiple items which may be from different sellers. However, each seller must be provided their own payment in full as the sellers typically do not have any relationship with one another. Furthermore, the various payment processors typically have different requirements.

For example, some payment processors can require that each purchase be authorized individually, thus requiring multiple payment captures. Other payment processors may require a single authorization even if multiple purchases are being made. For example, PayPal is session-based and a unique session may be created for each payment session, thus allowing only one authorization for a given payment amount even if there are multiple payment recipients. In this case, each must be paid in full or not at all, and thus the total payment amount must be captured, the total amount including each individual payment amount for each seller.

In various embodiments, orchestration engine 110 may be configured to implement various payment processor requirements for a given cart action or transaction. The orchestration engine 110 may also be configured to determine payment processor requirements based on geographic region, country, or other entity that may impose unique payment processor requirements. Requirements for payment processors may vary from country to country. For example, Discover only performs multiple log-in/multiple transfer transactions in the U.S., whereas Visa only performs single log-in/multiple processors.

Another payment type that the orchestration engine 110 may consider are incentives. Incentives can include coupons that can be used to discount part or all of the cost of an item for a buyer, while providing payment from another payer or sponsor to the seller. A coupon may apply to one item, one seller, or equally to all sellers for a given cart. In an embodiment, the orchestration engine 110 may be configured to determine that all payments owed to a seller including incentives and payment captures are processed in their entirety. In other words, the orchestration engine 110 may ensure that the seller is paid the incentive amount and the remaining capture amount, and not just the incentive amount if the capture amount fails for some reason.

The orchestration engine 110 may further be configured to implement processes to analyze the dependencies of a multiple payment scenario to ensure that the entire cart or the entire user session is allowed to complete, even with multiple sellers and multiple payment types. In some embodiments, the orchestration engine 110 may implement a composite charge structure to represent and analyze the components of a composite payment. The composite charge structure may identify which are payments are single payments and which payments are multiple payments. For example, coupons may be considered single payments, as are incentives in general. Some credit card payments may be a multiple payment type and may be tracked differently.

The orchestration engine 110 may further be configured to determine if a credit card is unable to process the total amount. For example, only some payments may be authorized, but not all payments needed for the user session or user cart. For some carts, the entire transaction may be cancelled, implementing an all-or-nothing framework for purchase transactions. For example, a user may have three items, each priced at $30, in the user's cart that are each from different sellers. The user may further have a coupon that is applied to the total amount of $90, the coupon being valued at 10%, or a discount of $9. Each seller should be credited $3 for the coupon portion, and the remaining amount to be funded is $81. If the payment method is PayPal, then a single transaction is required. Therefore, a single authorization for $81 may be processed via a single API call to the PayPal payment processor.

More generally, the orchestration engine 110 may be configured to determine which portions of a user's cart require single or multiple payments, and which of the payments are associated with the same item or seller. An analysis of these dependencies may be used to identify different groupings or buckets. Additionally or optionally, the orchestration engine 110 may determine that the entire cart must be fulfilled entirely or not at all.

Optionally, the orchestration engine 110 may determine that one or more buckets must be fulfilled entirely or not at all. In some cases, a cart transaction may be partially fulfilled. For example, if the incentive in the example above fails for the third item, then the payment for the third item can be marked as failed. However, for a payment method such as PayPal that requires single transactions, if the first of multiple payments fail, then the following payments will fail. However, if the failed payment occurred after other payments were already captured, then the captured payments may be fulfilled.

One advantage of implementing an orchestration engine 110 to analyze a composite payment prior to execution is that payment processors typically charge a fee for each API call. The e-commerce site can thus save operational costs by avoiding unnecessary calls to payment processors using the described techniques. More generally, the orchestration engine 110 may be configured to analyze and process various combinations of payment types and requirements, including various payment processors such as credit cards, PayPal, and the like, various incentives such as coupons and discounts, and other payment types such as seller credit or store credit.

In some embodiments, the orchestration engine 110 may be configured to use connected components of a graphing algorithm to identify the payments that need to be processed as a single unit. Based on the requirements, policies, and payment processor capabilities, a configuration may be generated. Based on this configuration, the payments may be divided into groups based on their associated payment methods. These groups may then be checked with respect to the checkout cart to create super-groups or buckets based on the payments that fund a single item. Each super-group or bucket now has a list of groups where each group has a payment or a list of payments of a single type. Each of these single groups may then be processed by the payment processor(s). This list of super-groups or buckets may be represented as an execution graph that may be executed to process the payments. The orchestration engine 110 may be configured to support various types of payment methods in a single checkout. For example, a combination of PayPal, credit card, incentives, and direct debit may be processed in a single checkout.

By implementing a graphing technique, the orchestration engine 110 may capture transitive operations and determine whether a desired set of transactions can be successfully completed. In one example, a user selects items from three sellers for a single cart action. The item from Seller 3 will use both incentive (P4) and credit card (P3), and Seller 2 will use a credit card only (P2). Seller 1 will use only an incentive (P1). It would be desirable to perform a single authorization for the credit card and incentive processes. In an example, orchestration engine 110 may form a link between P3 and P4 because they are part of the same order from the same seller. The orchestration engine 110 may also form a link between P2 and P3 to represent that a single authorization for payment for the credit card is desired. The orchestration engine 110 may further form a link between P1 and P4 to represent that a single authorization for the incentive is required.

By linking the various payment types in this manner, the orchestration engine 110 may further determine that a link between P1 and P2 can be indirectly inferred because the incentive associated with P1 is linked to the incentive for P4, and because credit card P3 and P2 are linked. The linked graph may thus be used to determine dependencies in a composite transaction that may be missed without such analysis.

The orchestration engine 110 may further form groups or buckets based on the dependencies for the various payment methods. P3 and P4 form a composite payment group 1; P1 and P4 form another group based on incentives; and P2 and P3 form a third group based on credit

The present disclosure further provides a way to encode rules and requirements pertaining to payment processors and methods using a format that enables the rules to be encoded and updated independently from the software. The execution of composite payments in an e-commerce system can be dependent upon a number of variables. For example, the requirements pertaining to credit card processing is typically based on a number of factors. These factors may include the geographic location of the buyer, the geographic location of the seller, the type of item, as well as other factors. For example, in the U.S., Visa is allowed to process multiple payments in a single transaction, whereas in Germany (EU), Visa payments can only be processed as single payments. In various embodiments, the various payment settings and requirements may be defined in a configuration file that can be updated via an external application, where the configuration file is not part of the orchestration engine software.

The payment settings and requirements typically change over the course of time. Correct analysis of composite transactions requires updating the system as the settings are updated. The manual updating of systems and software to update the settings can be costly and time-consuming due to the large number of dependencies and conditions for the various payment processors. The effort and delay required to update systems and software due to changes in rules as described above may have a number of detrimental effects. For example, multiple payment authorizations may be requested that are unnecessary. From a resource standpoint, processing updates and troubleshooting incompatibilities may unnecessarily consume computing, storage, and network resources.

The present disclosure provides a way to encode such rules using a standardized format that enables the rules to be encoded and updated independently from the software. The rules and settings (such as credit card processing rules) may be represented as data in a table or other data structure, where each row is a payment type and each row entry can be a value indicating a given setting such as whether multiple payments are allowed. Data structures other than tables can also be used. Each row entry may have a multi-value attribute that defines various payment processor settings. For example, a row may include:

| | |
|---|---|
| PAYMENT_ID | ID for payment type |
| LOCATION | Country or region |
| MULTIPLE_ALLOWED | Multiple transactions allowed |
| SINGLE_ONLY | Single payment only |

The data structure can be encoded using a language-independent format such as JavaScript Object Notation (JSON), which can be read by a number of languages without requiring a parser. The disclosed techniques can be used for any type of payment processor settings that have a number of dependencies.

Referring to the appended drawings, in which like numerals represent like elements throughout the several FIGURES, aspects of various technologies for encoding rules will be described. In the following detailed description, references are made to the accompanying drawings that form a part hereof, and which are shown by way of illustration specific configurations or examples.

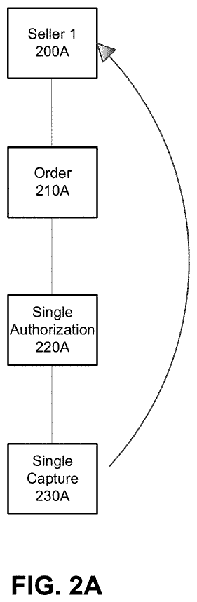

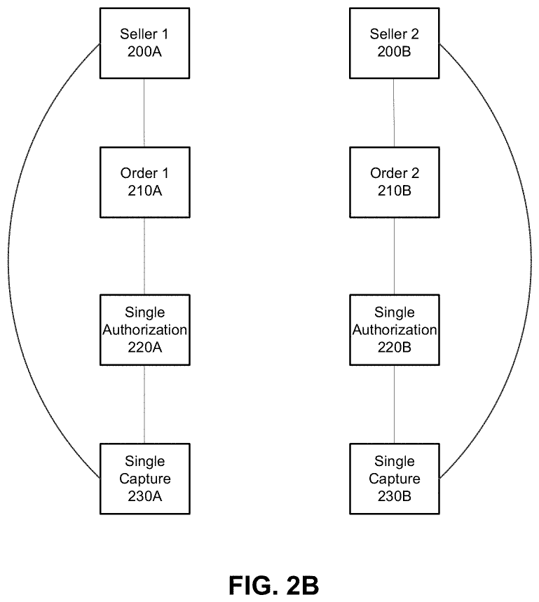

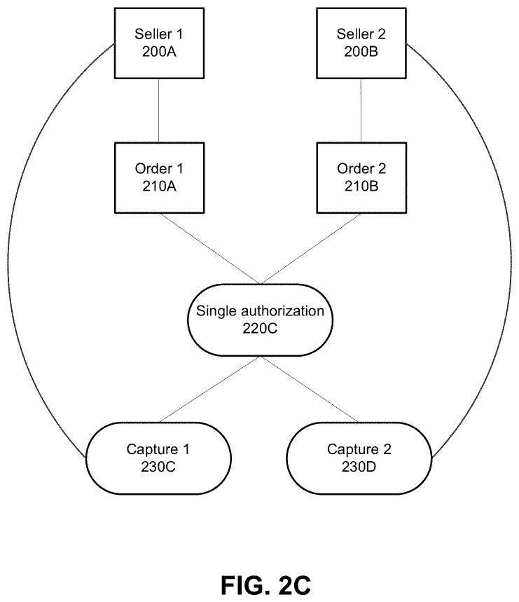

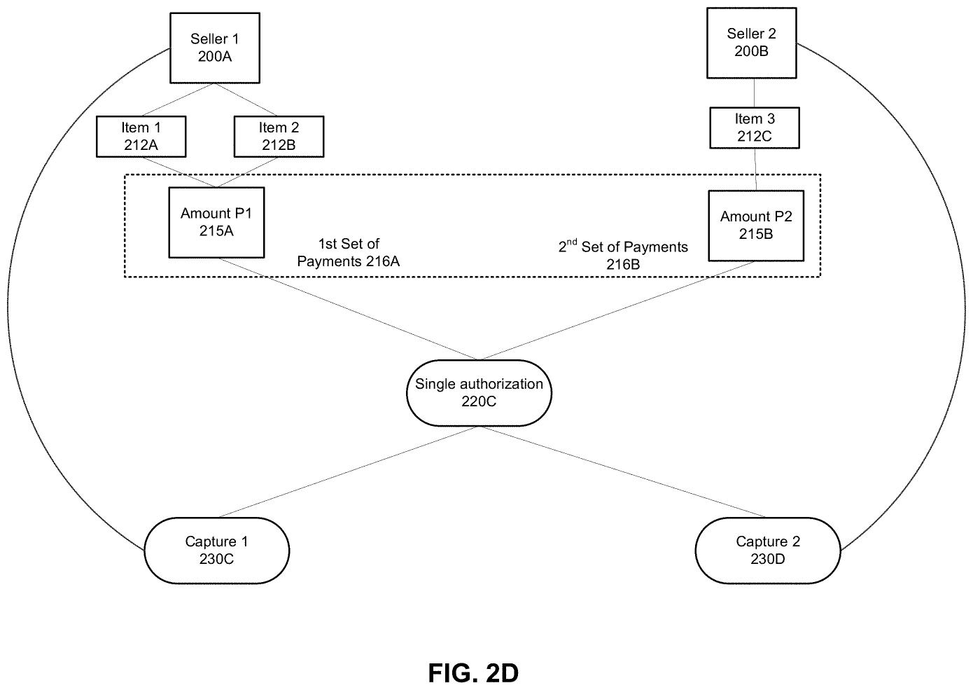

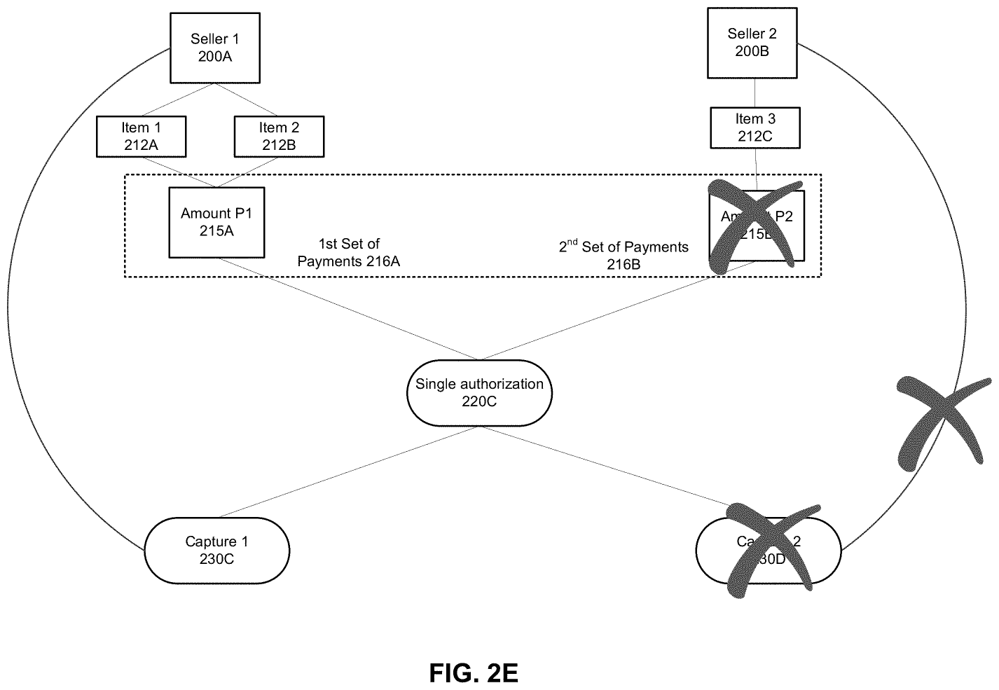

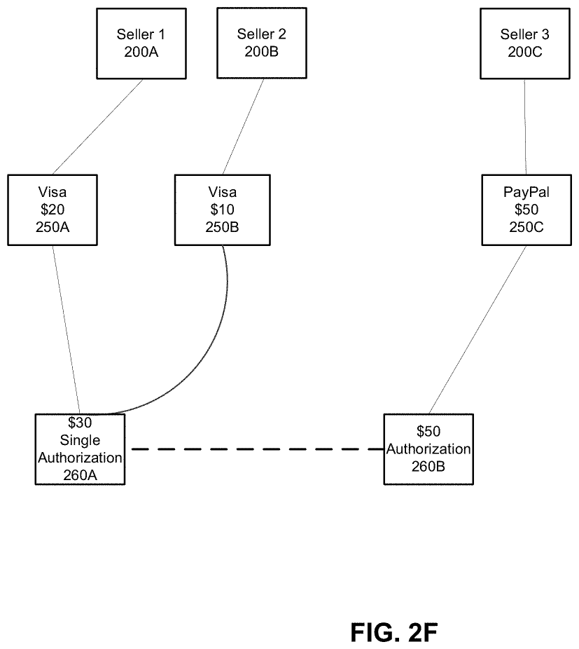

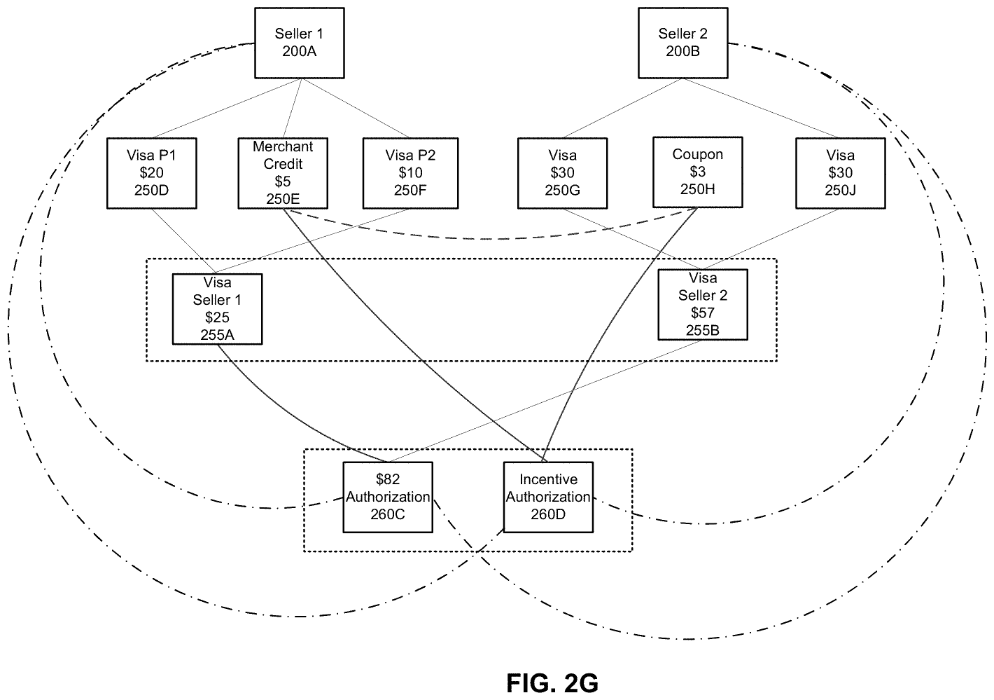

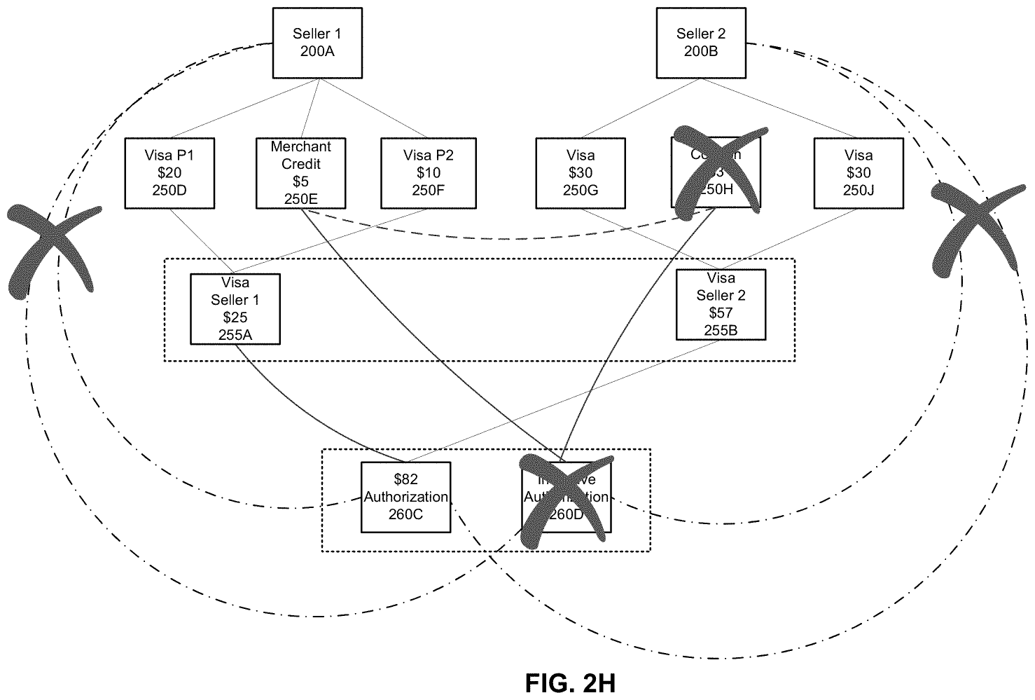

As discussed above, FIG. 1 illustrates a system 100 that implements orchestration engine 110. FIG. 2A shows an example linked graph illustrating a single transaction from Seller 1 200A where a single order 210A can be processed using a single authorization 220A resulting in a single payment capture 230A. The captured amount may be transferred to Seller 1 200A.

FIG. 2B shows an example linked graph illustrating two transactions associated with two sellers. The figure shows a single transaction from Seller 1 200A where a single order 210A can be processed using a single authorization 220A resulting in a single payment capture 230A. The captured amount may be transferred to Seller 1 200A. The figure also shows a single transaction from Seller 2 200B where a single order 210B can be processed using a second single authorization 220B resulting in a second payment capture 230B. The captured amount may be transferred to Seller 1 200B. In this example, two payment authorization requests are sent to the associated payment processor.

FIG. 2C shows an example linked graph illustrating two transactions associated with two sellers, where a single payment authorization is orchestrated. The figure shows a single transaction from Seller 1 200A where a single order 210A and a single transaction from Seller 2 200B. The orchestration engine may recognize that the two transactions can be processed using a single authorization 220C. This may be followed by payment captures 230C and 230D. The individual amounts for Order 1 210A and Order 2 210B from the captured amounts may be transferred to Seller 1 200A and to Seller 1 200B. In this example, a single payment authorization request is sent to the associated payment processor.

FIG. 2D shows an example linked graph illustrating multiple transactions associated with two sellers, where a single payment authorization is orchestrated. The figure shows two items 212A and 212B from Seller 1 200A which may be a single order for Seller 1. The cost for the two items may be represented as Amount P1 215A and is to be processed as a first set of payments 216A. The figures also show Item 3 212C which is the order for Seller 2 200B which is represented by Amount P2 215B and is to be processed as a second set of payments 216B. The orchestration engine may recognize that the two amounts can be processed using a single authorization 220C. Authorization may be followed by payment captures 230C and 230D. The individual amounts for Order 1 210A and Order 2 210B from the captured amounts may be transferred to Seller 1 200A and to Seller 1 200B. In this example, a single payment authorization request is sent to the associated payment processor.

FIG. 2E shows an example linked graph illustrating multiple transactions associated with two sellers, where a single payment authorization is orchestrated and where a portion of the entire set of transactions may fail or be voided. The figure shows two items 212A and 212B from Seller 1 200A which may be a single order for Seller 1. The cost for the two items may be represented as Amount P1 215A and is to be processed as a first set of payments 216A. The figure also shows Item 3 212 C which is the order for Seller 2 200B which is represented by Amount P2 215B and is to be processed as a second set of payments 216B. The orchestration engine may recognize that the two amounts can be processed using a single authorization 220C. Authorization may be followed by two payment captures 230C and 230D. In this example, the sets of payments may be partially fulfilled. For example, the amount P2 215B may be voided. If the voided amount occurred after first amount Plis already captured, then the captured payments may be fulfilled. The individual amounts for Order 1 210A and Order 2 210B from the captured amount may be transferred to Seller 1 200A, while there is no payment to Seller 1 200B.

FIG. 2F illustrates an example composite transaction with Seller 1 200A who requires a Visa payment, Seller 2 200B who requires a Visa payment, and Seller 2 200C who requires a PayPal payment. The amount to be provided to Seller 1 200A may be represented as Visa Amount 250A. The amount to be provided to Seller 2 200B may be represented as Visa Amount 250B. The orchestration engine may recognize that these two amounts can be processed using a single authorization 260. The figure also illustrates that the amount to be provided to Seller 3 200C may be represented as PayPal Amount 250C and is processed as Authorization 260B. The individual amounts for Visa 250A and Visa 250B from the amount captured in Authorization 260A may be transferred to Seller 1 200A and Seller 2 200B, and the amount captured in Authorization 260B may be transferred to Seller 3 200C.

FIG. 2G illustrates an example composite transaction including various incentives such as a coupon and merchant credit. within this example, Seller 1 200A requires a Visa payment and Seller 2 200B requires a PayPal payment. In addition to two Visa amounts 250D and 250F to be provided to Seller 1 200A, a merchant credit 250E is also to be applied. The Visa amount to be provided to Seller 1 200A may be represented as Visa Amount 255A. In addition to two Visa amounts 250G and 250J to be provided to Seller 2 200B, a coupon 250H is also to be applied. The Visa amount to be provided to Seller 2 200B may be represented as Visa Amount 255B. The orchestration engine may recognize that the two Visa amounts 255A and 255B can be processed using a single Visa authorization 260C. The orchestration engine may also recognize that the two incentive amounts 250E and 250H can be processed using a single incentive authorization 260D. The individual amounts for Visa 255A and Visa 255B from the amount captured in Authorization 260C may be transferred to Seller 1 200A and Seller 2 200B, and the incentive amounts captured in Authorization 260D may be transferred to Seller 1 200A and Seller 2 200B Seller 3 200C.

FIG. 2H illustrates an example composite transaction including various incentives such as a coupon and merchant credit, where part of the set of transactions has failed or is voided. within this example, Seller 1 200A requires a Visa payment and Seller 2 200B requires a PayPal payment. In addition to two Visa amounts 250D and 250F to be provided to Seller 1 200A, a merchant credit 250E is also to be applied. The Visa amount to be provided to Seller 1 200A may be represented as Visa Amount 255A. In addition to two Visa amounts 250G and 250J to be provided to Seller 2 200B, a coupon 250H is also to be applied. The Visa amount to be provided to Seller 2 200B may be represented as Visa Amount 255B. The orchestration engine may recognize that the two Visa amounts 255A and 255B can be processed using a single Visa authorization 260C. The orchestration engine may also recognize that the two incentive amounts 250E and 250H can be processed using a single incentive authorization 260D. In this example, if the coupon incentive 250 fails, then the incentive authorization 260D may fail. In one embodiment, an “all or nothing” policy may be implemented where if any incentive fails, then the entire set of transactions represented in the figure may be voided or failed. In this case, the user may be provided an option to modify the cart action. The user may, for example, remove one of the incentives and retry the cart action. In another embodiment, if partial payments are allowed, then the individual amounts for Visa 255A and Visa 255B from the amount captured in Authorization 260C may be transferred to Seller 1 200A and Seller 2 200B may be provided without the incentive amounts. Alternatively, the incentive amount successfully captured in Authorization 260D may be transferred to Seller 1 200A only.

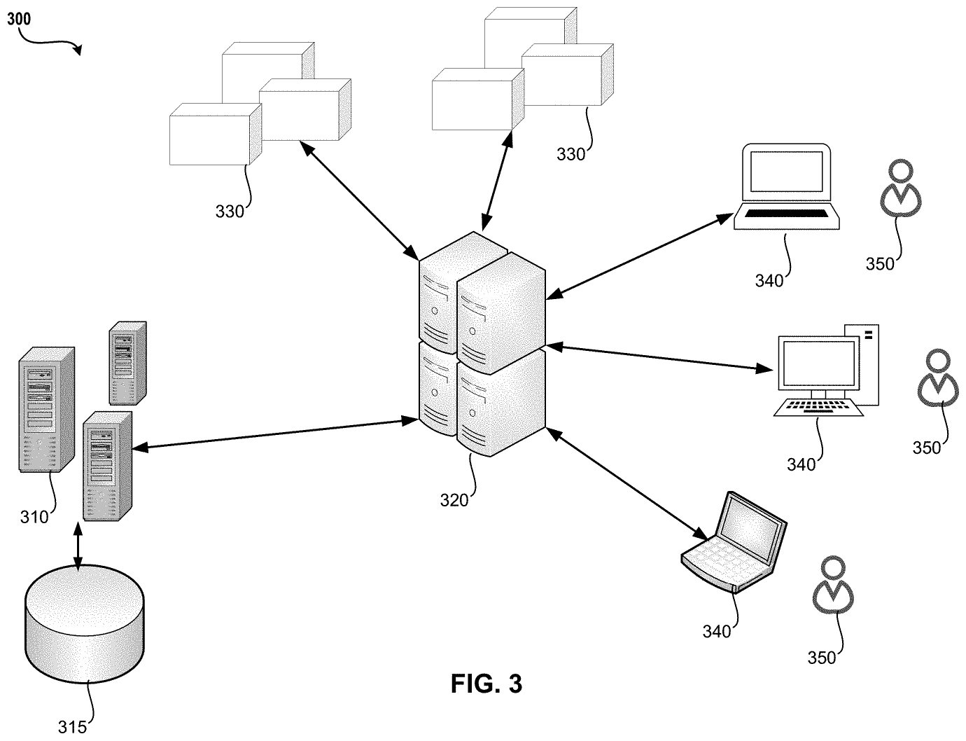

FIG. 3 illustrates a block diagram showing an example environment where a platform such as e-commerce platform 110 may be implemented. FIG. 3 illustrates an e-commerce environment 300 that may include servers 310. The servers 310 may comprise one or more servers, which may collectively referred to as “server.” The e-commerce environment 300 may further include a database 315, which may be configured to store various information used by the server 310 including product data, user data, rules data, and the like. The e-commerce environment 300 may further include communications server 320, which, for example, enables network communication between the server 310, online servers 330, and client devices 340. The client devices 340 may be any type of computing device that may be used by users 350 to connect with the server 310 over a communications network. Users 350 may be, for example, users who are accessing services provided by communications server 330 and/or online servers 330. The servers 330 may be operated by any party that is involved in providing, for example, online services. For example, the servers 330 may be configured to implement auction sites or online transactions. Accordingly, the servers 330 may be any type of computing device described herein as may be operated by an auction broker, a financial institution, and the like. The servers and devices represented in FIG. 3 communicate via various network communications hardware and software to facilitate the collection and exchange of data for use in a networked environment.

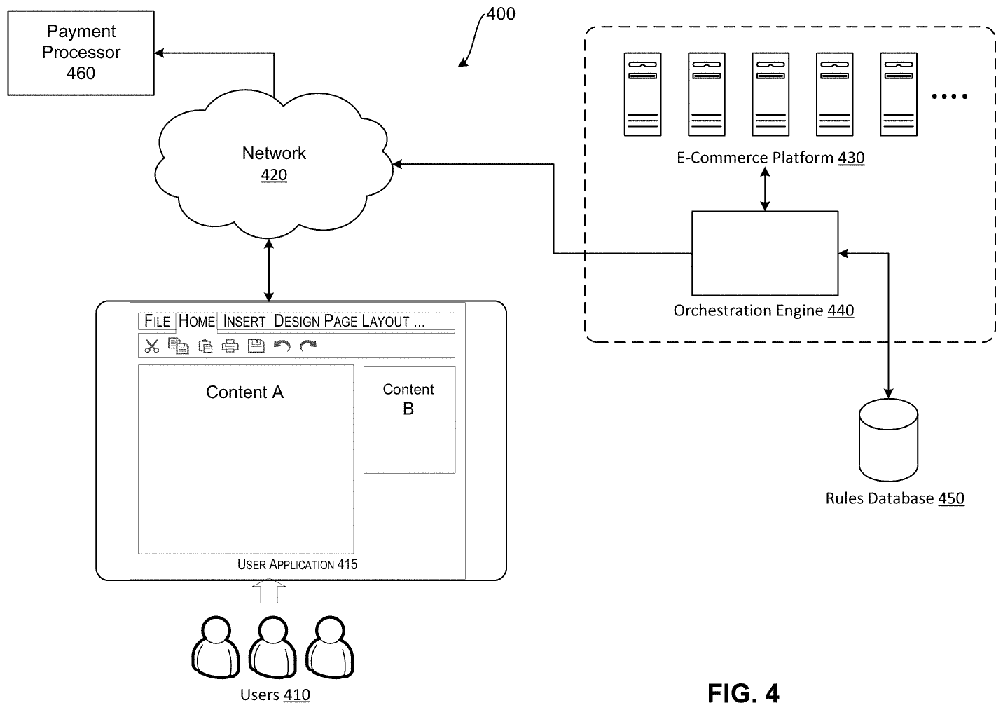

FIG. 4 is a computing system architecture diagram showing an overview of a system disclosed herein for implementing a rules-based encoding technique, according to one embodiment disclosed herein. As shown in FIG. 4, an e-commerce system 400 may be configured to perform product fulfillment and value calculations, or other functions based upon various data collected by and processed by data analysis components of an e-commerce platform 430. The e-commerce platform 430 may, for example, include, but are not limited to, physical computing devices such as server computers or other types of hosts, associated hardware components (e.g. memory and mass storage devices), and networking components (e.g. routers, switches, and cables). The e-commerce platform 430 can also include software, such as operating systems, applications, and containers, network services, virtual components, such as virtual disks, virtual networks, and virtual machines. The e-commerce platform 430 may communicate with or implement orchestration engine 440 that is configured to access a rules database 450 and send requests to payment processor 460. The orchestration engine 440 may be part of the e-commerce platform 430. The rules database 450 can include data, such as a database, or a database shard (i.e. a partition of a database), and may store various rules for payment processors. Data may be provided to the user application 415 to provide results to various users 410 using a user application 415. A query function may be used to query the rules database 450 for the latest rules information.

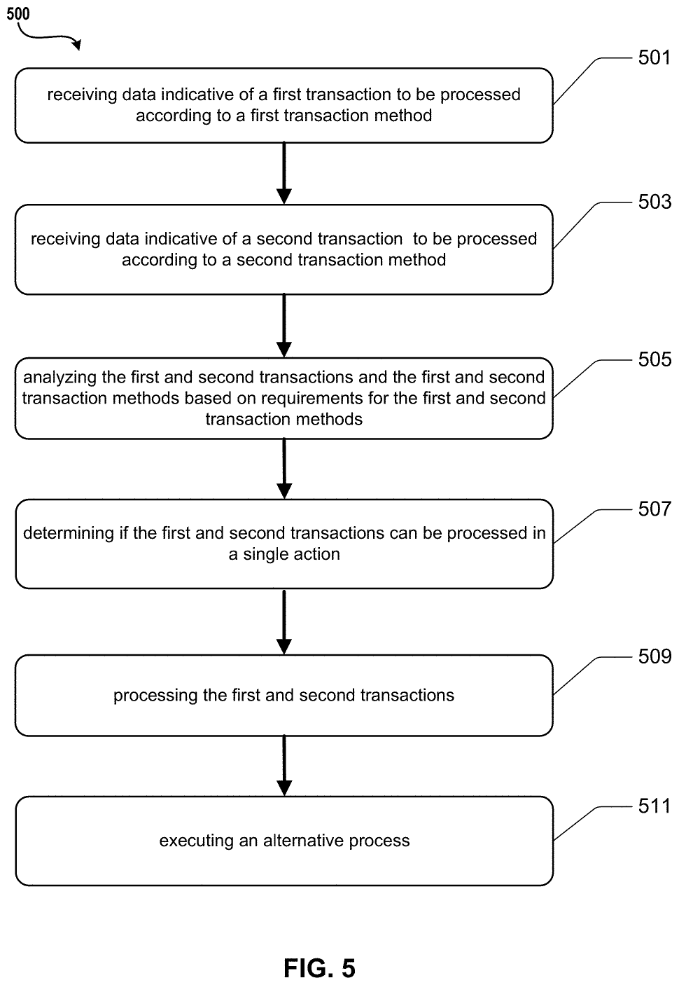

FIG. 5 is a diagram illustrating aspects of a routine 500 for implementing some of the techniques disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

The routine 500 begins at operation 501, which illustrates receiving data indicative of a first transaction to be processed according to a first transaction method.

The routine 500 then proceeds to operation 503, which illustrates receiving data indicative of a second transaction to be processed according to a second transaction method. Operation 505 illustrates analyzing the first and second transactions and the first and second transaction methods based on requirements for the first and second transaction methods. Next, operation 507 illustrates based on the analysis, determining if the first and second transactions can be processed in a single action. Operation 509 illustrates when the analysis indicates that the first and second transactions can be processed in a single action, processing the first and second transactions as a single action. Operation 511 illustrates when the analysis indicates that the first and second transactions cannot be processed in a single action, executing an alternative process.

In an embodiment, the alternative process is to process the first and second transactions separately. In an embodiment, the alternative process comprises generating a notification that the first and second transactions cannot be processed in a single action; and providing one or more options for modifying the first and second transactions or the first and second transaction methods. In an embodiment, the alternative process comprises generating a notification that the first and second transactions cannot be processed in a single action; and processing a subset of the first and second transactions.

In an embodiment, the analyzing comprises generating a data structure that maps the first and second transactions and the first and second transaction methods based on the requirements for the first and second transaction methods.

In an embodiment, an ordered set of processes operable to process the first and second transactions in the single action or as separate actions is determined. In an embodiment, the requirements for the first and second transaction methods are received as settings data that is represented in a language-independent format. In an embodiment, the language-independent data format is JSON. In an embodiment, the return results of one or more actions to a requesting process.

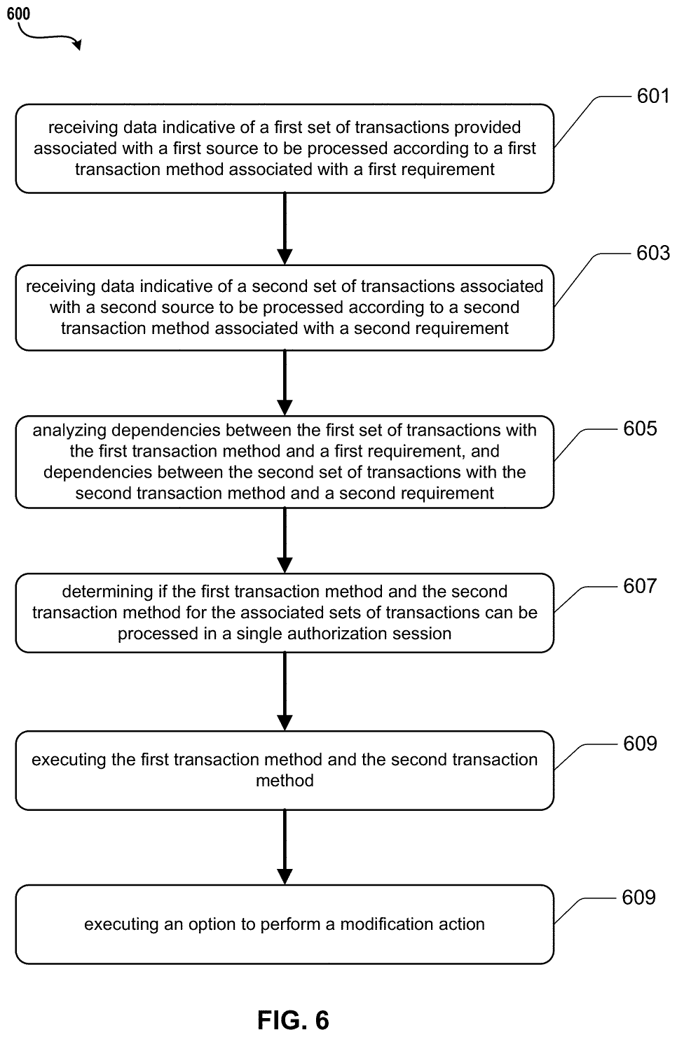

FIG. 6 is a diagram illustrating aspects of a routine 600 for implementing some of the techniques disclosed herein.

The routine 600 begins at operation 601, which illustrates receiving data indicative of a first set of transactions provided from a first source to be processed according to a first transaction method associated with a first requirement. In an embodiment, the first requirement specifies that the first set of transactions can be processed as separate transactions. The routine 600 then proceeds to operation 603, which illustrates receiving data indicative of a second set of transactions provided by a second source to be processed according to a second transaction method associated with a second requirement. In an embodiment, the second requirement specifies that the second set of transactions must be processed as a single transaction. Operation 605 illustrates analyzing dependencies between the first set of transactions with the first transaction method and a first requirement, and analyzing dependencies between the second set of transactions with the second transaction method and a second requirement. Operation 607 illustrates based on the analysis, determining if the first transaction method and the second transaction method for the associated sets of transactions can be processed in a single authorization session. Operation 609 illustrates if the first transaction method and the second transaction method fulfill the first requirement and the second requirement within the single authorization session, executing the first transaction method and the second transaction method. Operation 611 illustrates if the first transaction method and the second transaction method cause a conflict with the first requirement or the second requirement within the single authorization session, executing an option to perform a modification action.

In an embodiment, a hierarchical data structure that maps dependencies between the first set of transactions with the first transaction method and the first requirement, and maps dependencies between the second set of transactions with the second transaction method and the second requirement, are generated.

In an embodiment, the hierarchical data structure is analyzed to determine if an ordered set of operations fulfill the first requirement and the second requirement by use of the first transaction method and the second transaction method for the associated sets of transactions in a single session.

In an embodiment, the modification action comprises generating a notification that the first and second sets of transactions could not be fulfilled in a single session; and providing one or more recommended options for modifying the first and second sets of transactions or the first and second transaction methods.

In an embodiment, the modification action comprises generating a notification that the first and second sets of transactions could not be fulfilled in a single session; selecting a subset of the first and second sets of items based on one or more policies; and processing the selected subset of the first and second sets of transactions.

In an embodiment, the hierarchical data structure is further generated based on one or more policies defining additional requirements for the first and second transaction methods.

In an embodiment, the requirements for the first and second transaction methods are received as settings data that is represented in a language-independent format.

In an embodiment, the data is input via an application programming interface (API) configured to receive the data and return results of the single authorization session to a requesting process

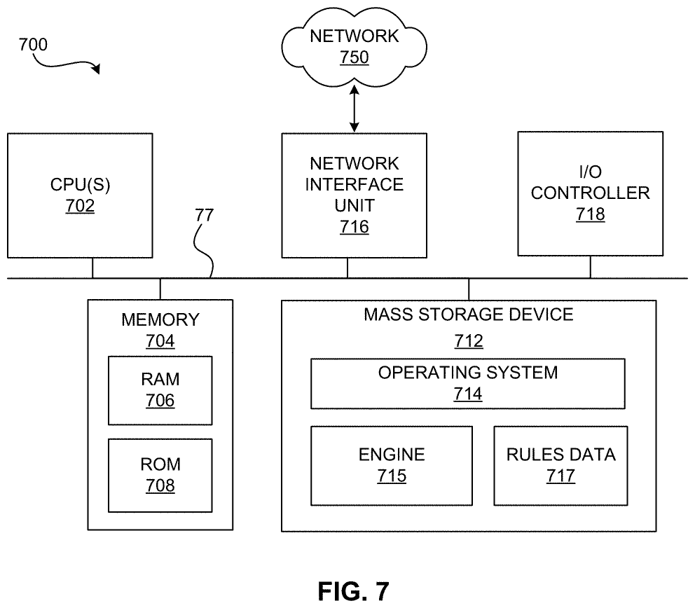

FIG. 7 shows an example computer architecture for a computer capable of providing the functionality described herein such as, for example, a computing device configured to implement the functionality described above with reference to FIGS. 1-6. Thus, the computer architecture 700 illustrated in FIG. 7 illustrates an architecture for a server computer or another type of computing device suitable for implementing the functionality described herein. The computer architecture 700 might be utilized to execute the various software components presented herein to implement the disclosed technologies.

The computer architecture 700 illustrated in FIG. 7 includes a central processing unit 702 (“CPU”), a system memory 704, including a random-access memory 706 (“RAM”) and a read-only memory (“ROM”) 708, and a system bus 77 that couples the memory 704 to the CPU 702. A firmware containing basic routines that help to transfer information between elements within the computer architecture 700, such as during startup, is stored in the ROM 708. The computer architecture 700 further includes a mass storage device 712 for storing an operating system 714, other data, and one or more executable programs, such as storing engine 715 or storing rules data 717.

The mass storage device 712 is connected to the CPU 702 through a mass storage controller (not shown) connected to the bus 77. The mass storage device 712 and its associated computer-readable media provide non-volatile storage for the computer architecture 700. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various implementations, the computer architecture 700 might operate in a networked environment using logical connections to remote computers through a network 750 and/or another network (not shown). A computing device implementing the computer architecture 700 might connect to the network 750 through a network interface unit 716 connected to the bus 77. It should be appreciated that the network interface unit 716 might also be utilized to connect to other types of networks and remote computer systems.

The computer architecture 700 might also include an input/output controller 718 for receiving and processing input from a number of other devices, including a keyboard, mouse, or electronic stylus (not shown in FIG. 7). Similarly, the input/output controller 718 might provide output to a display screen, a printer, or other type of output device (also not shown in FIG. 7).

It should be appreciated that the software components described herein might, when loaded into the CPU 702 and executed, transform the CPU 702 and the overall computer architecture 700 from a general-purpose computing system into a special-purpose computing system customized to facilitate the functionality presented herein. The CPU 702 might be constructed from any number of transistors or other discrete circuit elements, which might individually or collectively assume any number of states. More specifically, the CPU 702 might operate as a finite-state machine, in response to executable instructions contained within the software modules disclosed herein. These computer-executable instructions might transform the CPU 702 by specifying how the CPU 702 transitions between states, thereby transforming the transistors or other discrete hardware elements constituting the CPU 702.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 might include other types of computing devices, including hand-held computers, embedded computer systems, personal digital assistants, and other types of computing devices known to those skilled in the art.

It is also contemplated that the computer architecture 700 might not include all of the components shown in FIG. 7, might include other components that are not explicitly shown in FIG. 7, or might utilize an architecture completely different than that shown in FIG. 7. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

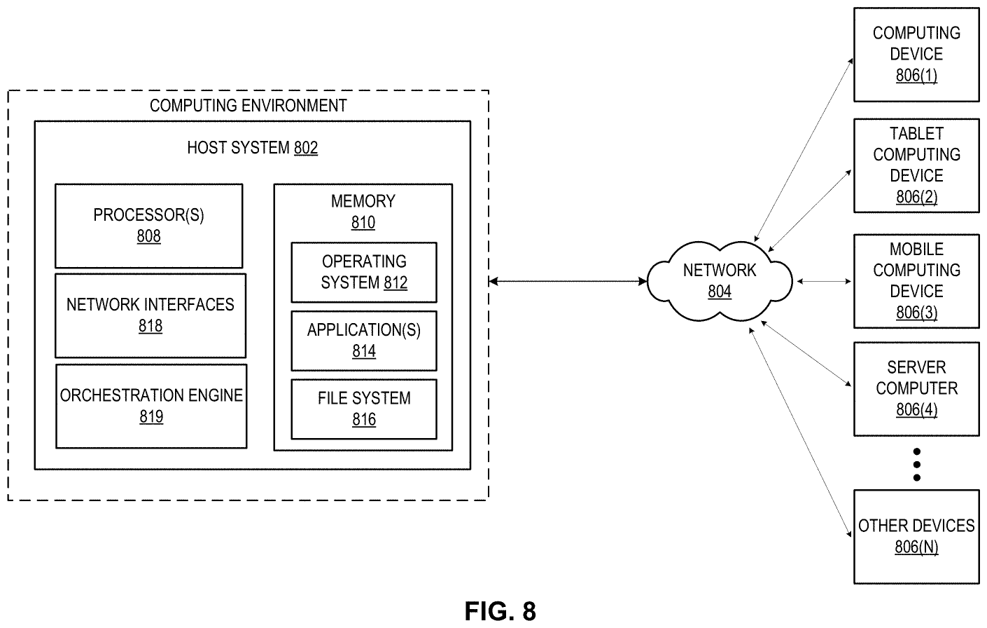

FIG. 8 illustrates an example computing environment capable of executing the techniques and processes described above with respect to FIGS. 1-7. In various examples, the computing environment comprises a host system 802. In various examples, the host system 802 operates on, in communication with, or as part of a network 804.

The network 804 can be or can include various access networks. For example, one or more client devices 806( 1 ) . . . 806(N) can communicate with the host system 802 via the network 804 and/or other connections. The host system 802 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 802 can be provided by one or more servers that are executing as part of, or in communication with, the network 804. A server can host various services, virtual machines, portals, and/or other resources. For example, a can host or provide access to one or more portals, Web sites, and/or other information.

The host system 802 can include processor(s) 808 and memory 810. The memory 810 can comprise an operating system 812, application(s) 814, and/or a file system 816. Moreover, the memory 810 can comprise the storage unit(s) 82 described above with respect to FIGS. 1-7.

The processor(s) 808 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 810.

The memory 810 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 802 can communicate over the network 804 via network interfaces 818. The network interfaces 818 can include various types of network hardware and software for supporting communications between two or more devices. The host system 802 may also include orchestration engine 819, which may be configured to implement aspects of the functionality disclosed herein.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines are described herein as being implemented, at least in part, by an application, component, and/or circuit. Although the following illustration refers to the components of specified figures, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

In closing, although the various technologies presented herein have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for efficiently processing data in a computing system, the method comprising:
receiving data indicative of a first transaction to be processed according to a first transaction method;
receiving data indicative of a second transaction to be processed according to a second transaction method;
analyzing the first and second transactions and the first and second transaction methods based on requirements for the first and second transaction methods;
based on the analysis, determining if the first and second transactions can be processed in a single action;
when the analysis indicates that the first and second transactions can be processed in a single action, processing the first and second transactions as a single action; and
when the analysis indicates that the first and second transactions cannot be processed in a single action, executing an alternative process.

2. The method of claim 1, wherein the alternative process is to process the first and second transactions separately.

3. The method of claim 1, wherein the alternative process comprises:
generating a notification that the first and second transactions cannot be processed in a single action; and
providing one or more options for modifying the first and second transactions or the first and second transaction methods.

4. The method of claim 1, wherein the alternative process comprises:
generating a notification that the first and second transactions cannot be processed in a single action; and
processing a subset of the first and second transactions.

5. The method of claim 1, wherein the analyzing comprises generating a data structure that maps the first and second transactions and the first and second transaction methods based on the requirements for the first and second transaction methods.

6. The method of claim 1, further comprising determining an ordered set of processes operable to process the first and second transactions in the single action or as separate actions.

7. The method of claim 1, wherein the requirements for the first and second transaction methods are received as settings data that is represented in a language-independent format.

8. The method of claim 7, wherein the language-independent format is JSON.

9. The method of claim 1, wherein the data is input via an application programming interface (API) configured to receive the data and return results of one or more actions to a requesting process.

10. A computing system, comprising:
one or more processors; and
a computer-readable storage medium having computer-executable instructions stored thereupon which, when executed by the processor, cause the processor to:
receive data indicative of a first set of transactions associated with a first source to be processed according to a first transaction method associated with a first requirement, the first requirement specifying that the first set of transactions can be processed as separate transactions;
receive data indicative of a second set of transactions associated with a second source to be processed according to a second transaction method associated with a second requirement, the second requirement specifying that the second set of transactions must be processed as a single transaction;
analyze dependencies between the first set of transactions with the first transaction method and a first requirement, and analyzing dependencies between the second set of transactions with the second transaction method and a second requirement;
based on the analysis, determine if the first transaction method and the second transaction method for the associated sets of transactions can be processed in a single authorization session;
if the first transaction method and the second transaction method fulfill the first requirement and the second requirement within the single authorization session, executing the first transaction method and the second transaction method; and
if the first transaction method and the second transaction method cause a conflict with the first requirement or the second requirement within the single authorization session, executing an option to perform a modification action.

11. The computing system of claim 10, further comprising generating a hierarchical data structure that maps dependencies between the first set of transactions with the first transaction method and the first requirement, and maps dependencies between the second set of transactions with the second transaction method and the second requirement.

12. The computing system of claim 11, further comprising analyzing the hierarchical data structure to determine if an ordered set of operations fulfill the first requirement and the second requirement by use of the first transaction method and the second transaction method for the associated sets of transactions in a single session.

13. The computing system of claim 10, wherein the modification action comprises:
generating a notification that the first and second sets of transactions could not be fulfilled in a single session; and
providing one or more recommended options for modifying the first and second sets of transactions or the first and second transaction methods.

14. The computing system of claim 10, wherein the modification action comprises:
generating a notification that the first and second sets of items could not be fulfilled in a single session;
selecting a subset of the first and second sets of items based on one or more policies; and
processing the selected subset of the first and second sets of items.

15. The computing system of claim 11, wherein the hierarchical data structure is further generated based on one or more policies defining additional requirements for the first and second transaction methods.

16. The computing system of claim 10, wherein the requirements for the first and second transaction methods are received as settings data that is represented in a language-independent format.

17. A computer-readable storage medium having computer-executable instructions stored thereupon which, when executed by a processor of a computing device, cause the computing device to:
receiving data indicative of a first set of items to be processed according to a first transaction method;
receiving data indicative of a second set of items to be processed according to a second transaction method;
analyzing the first and second set of items and the first and second transaction methods based on requirements for the first and second transaction methods;
based on the analysis, determining if the first and second sets of items can be processed in a single action;
when the analysis indicates that the first and second sets of items can be processed in a single action, processing the first and second sets of items; and
when the analysis indicates that the first and second sets of items cannot be processed in a single action, executing a process to modify the first or second set of items.

18. The computer-readable storage medium of claim 17, wherein the process comprises:
generating a notification that the first and second sets of items cannot be processed in a single action; and
providing one or more options for modifying the first and second sets of items or the first and second transaction methods.

19. The computer-readable storage medium of claim 17, wherein the process comprises:
generating a notification that the first and second sets of items cannot be processed in a single action; and
processing a subset of the first and second sets of items.

20. The computer-readable storage medium of claim 17, wherein the analyzing comprises generating a data structure that maps the first and second set of items and the first and second transaction methods based on the requirements for the first and second transaction methods.
